(19) United States
(12) Patent Application Publication
(10) Pub. No.: US 2019/0348895 A1
(43) Pub. Date: Nov. 14, 2019

(54) ROLL BENDING MACHINE

(71) Applicant: DENSO CORPORATION, Kariya-city (JP)

(72) Inventors: Chiaki SASAKI, Kariya-city (JP); Kengo TAKESHITA, Kariya-city (JP); Hidemasa OTSUBO, Kariya-city (JP); Hiroki TAKAHASHI, Kariya-city (JP)

(21) Appl. No.: 16/408,513

(22) Filed: May 10, 2019

(30) Foreign Application Priority Data
May 11, 2018 (JP) 2018-091846

(51) Int. Cl. H02K 15/02; B21D 11/06; B21D 53/00; B21D 3/02

(52) U.S. Cl. CPC H02K 15/026; B21D 3/02; B21D 53/00; B21D 11/06

(57) ABSTRACT

A roll bending machine includes a roller unit and a tension device. The roller unit rolls and bends a strip member at a rolling rate varying in a width-wise direction of the strip member. The tension device applies tension to the strip member after being rolled by the roller unit in a rolling direction of the strip member, thereby reducing compressive stress which usually result in formation of wrinkles on the strip member. This minimizes the probability of formation of wrinkles on the strip member.

### CROSS REFERENCE TO RELATED DOCUMENT

The present application claims the benefit of priority of Japanese Patent Application No. 2018-91846 filed on May 11, 2018, the disclosure of which is incorporated herein by reference.

### BACKGROUND

### 1 Technical Field

This disclosure relates generally to a roll bending machine.

### 2 Background Art

There is known a technique for winding a strip member in a spiral form to make a stator core of an electric motor. Specifically, a steel strip is first punched to have a strip-shaped yoke with teeth. The yoke is then stretched in a spiral form with the teeth extending from the yoke radially inwardly. Such a spiral winding technique is also known which presses a strip member using tapered rollers to make a spiral strip with a constant radius of curvature.

The above rolling techniques, however, have a risk of producing wrinkles in the rolled strip member. Such a probability is usually increased with an increase in a value derived by dividing the width by the thickness of the strip member.

### SUMMARY

It is therefore an object of this disclosure to provide a roll bending machine which is capable of minimizing the probability of wrinkles on a rolled member.

According to one aspect of the invention, there is provided a roll bending machine which comprises: a roller unit which works to roll a strip member at a rolling rate varying in a width-wise direction of the strip member to bend the strip member; and a tension device which works to exert tension to the strip member after the strip member is rolled.

The application of tension to the strip member at a location downstream from the roller unit reduces compressive stress remaining in the strip member which usually results in formation of wrinkles on the strip member, thereby minimizing the possibility of wrinkles on the rolled strip member.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a perspective view which illustrates a steel strip rolled by a tapered roller;

FIG. 2 is a plan view which schematically illustrates a roll bending machine according to the first embodiment;

FIG. 3 is a transverse section taken along the line III-III in FIG. 2;

FIG. 4 is a transverse section taken along the line IV-IV in FIG. 2;

FIG. 5 is a plan view which schematically illustrates a roll bending machine according to the second embodiment;

FIG. 6 is a transverse section taken along the line VI-VI in FIG. 5;

FIG. 7 is a plan view which schematically illustrates a roll bending machine according to the third embodiment;

FIG. 8 is a transverse section taken along the line VIII-VIII in FIG. 7;

FIG. 9 is a plan view which schematically illustrates a roll bending machine according to the fourth embodiment;

FIG. 10 is a flowchart of logical steps executed by a machining condition changing unit of a roll bending machine according to the fourth embodiment; and

FIG. 11 is a plan view which schematically illustrates a roll bending machine according to the fifth embodiment.

### DESCRIPTION OF THE PREFERRED EMBODIMENT

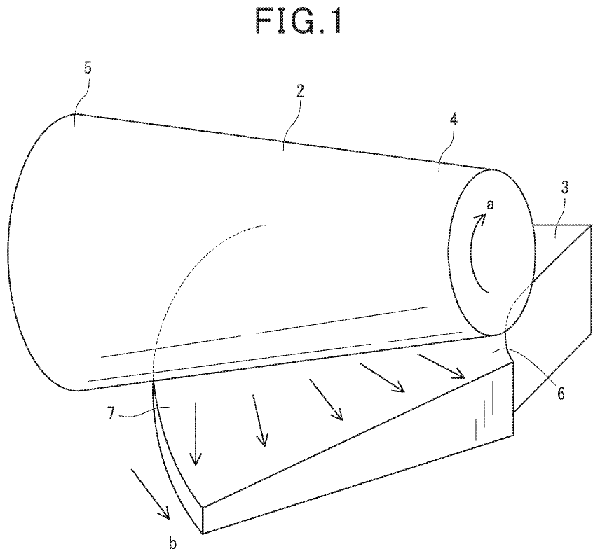

A mechanism in which wrinkles are created while a strip of the steel plate 3 is being extended using the tapered roller 2 so that it is bent or curved in an edge-wise direction thereof will first be discussed below using FIG. 1. “being bent in the edgewise direction”, as referred to herein, means that a strip member is bent in a direction in which short edges or sides of a transverse section of the strip member are opposed to each other. The tapered roller 2 is rotated in a direction indicated by the arrow a. The tapered roller 2 is shaped to have the small-diameter portion 4 and the large-diameter portion 5. An amount by which the steel plate 3 is elastically pressed by the large-diameter portion 5 to have a decreased thickness (which will also be referred to as an amount of rolling deformation) is set larger than that by which the steel plate 3 is elastically pressed by the small-diameter portion 4 to have a decreased thickness, thereby causing an amount by which the steel plate 3 is elongated in the rolling direction b (i.e., a direction of flow of the steel plate 3, in other words, a lengthwise direction of the steel plate 3) to be increased from the inner side 6 to the outer side of the steel plate 3. Bending a strip member in the edgewise direction using such a difference in elongated amount is referred to as roll bending in this discussion.

Ideally, material, as pressed by the tapered roller 2, is moved in the form of flows in the rolling direction which match a distribution of the pressure. However, end portions of the steel plate 3 are not restrained from being moved, so that material of the end portions will flow in the width-wise direction of the steel plate 3 as well as in the rolling direction, thereby resulting in a mismatch of the flows of the material with the distribution of the pressure. When compressive stress which is higher than buckling stress of the steel plate 3 remains in the end portions of the steel plate 3 after being rolled, it will result in wrinkles on the end portions.

A plurality of embodiments of a roll bending machine will be described below with reference to the drawings. The same or similar reference numbers throughout the drawings will refer to the same or similar parts, and explanation thereof in detail will be omitted here.

### First Embodiment

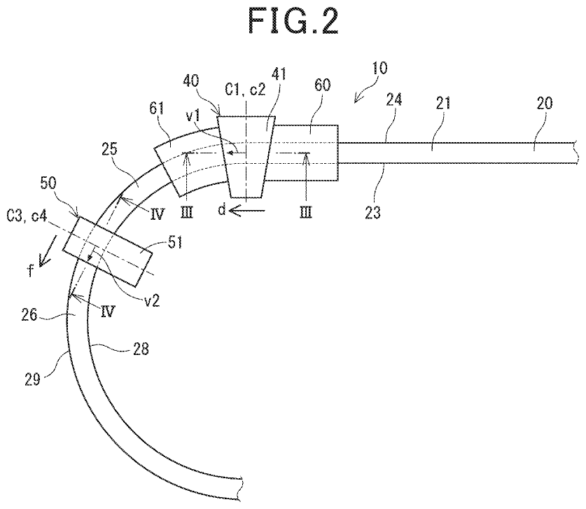

The first embodiment will be described with reference to FIGS. 2 to 4. The roll bending machine 10 is designed to subject the strip member 20 to rolling and bending and includes the roller unit 40, the tension device 50, the inlet guide 60, and the outlet guide 65. The strip member 20 that is an object to be rolled and bent is made of a plate in which a ratio, as derived by dividing the width of the plate by the thickness of the plate, is more than 10.

The roller unit 40 includes two rollers 41 and 42 which rotate while gripping a thickness of the strip member 20. The roller unit 40 works to roll and bend the strip member 20 at a rolling rate (i.e., a change or reduction in thickness of the strip member 20 arising from being rolled) varying in the width-wise direction of the strip member 20. In this embodiment, the rolling rate increases from one side to the other side of the strip member 20 in the width-wise direction thereof. This may be achieved by a difference in interval between outside edges of the rollers 41 and 42 through the thickness of the strip member 20 and between inside edges of the rollers 41 and 42 through the thickness of the strip member 20 or by changing an angle the axis of rotation of the roller 41 makes with the axis of rotation of the roller 42. The roller 41 serves to press the upper surface 21 of the strip member 20, while the roller 42 serves to press the lower surface 22 of the strip member 20. Each of the rollers 41 and 42 is shaped to have at least a portion which contacts with the strip member 20 and has an outer diameter increasing from one end to the other end of the portion in an axial direction thereof. Specifically, each of the rollers 41 and 42 is made of a tapered roller whose outer diameter changes linearly in the rotation axis c1 or c2. The roller 41 and the roller 42 are oriented to have axes of rotation extending substantially parallel to each other, thereby creating a difference in rolling rate between the outside and inside of the strip member 20 in the width-wise direction thereof.

The tension device 50 is equipped with two tension rollers 51 and 52 which rotate while gripping the thickness of the strip member 20 and apply tension to the strip member 20 at a location downstream of the roller unit 40 in the rolling direction d in which the strip member 20 has been rolled (i.e., the lengthwise direction of the steel member 20). The tension rollers 51 and 52 are made of parallel rollers. The tension device 50 may apply tension to the strip member 20 in a direction different from the rolling direction d, for example, in the width-wise direction of the strip member 20. The tension rollers 51 and 52 are arranged substantially parallel to each other.

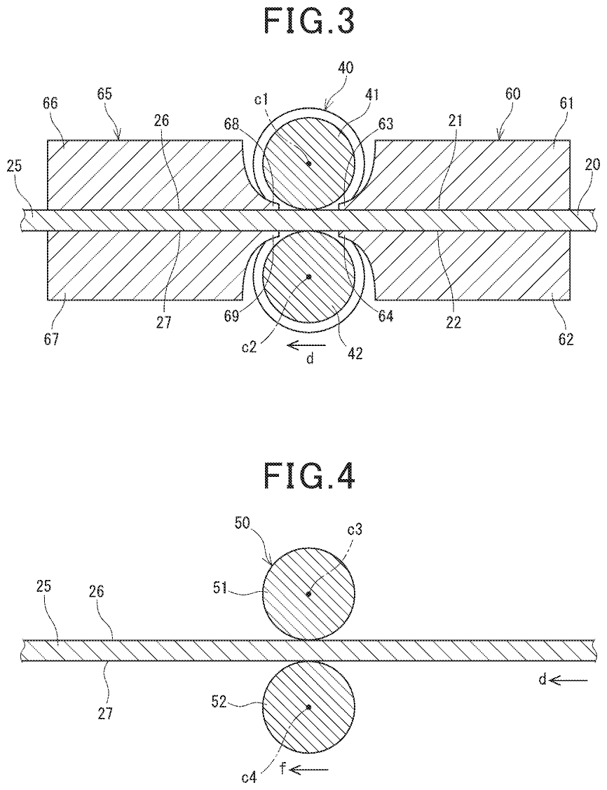

The inlet guide 60 works to limit or restrain movement of the strip member 20 both in the thickness-wise direction and in the width-wise direction of the strip member 20 before the strip member 20 is rolled by the roller unit 40. The inlet guide 60 is of a cylindrical shape extending in the lengthwise direction of the strip member 20. The inlet guide 60, as clearly illustrated in FIG. 3, includes the first inlet guide 61 and the second inlet guide 62. The first inlet guide 61 contacts the upper surface 21 of the strip member 20. The second inlet guide 62 contacts the lower surface 22, the side surface 23, and the side surface 24 of the strip member 20. The side surfaces 23 and 24 are opposed to each other through the width of the strip member 20.

The first inlet guide 61 has a recessed or concave portion which faces the roller 41. The first inlet guide 61 also has the protruding portion 63 which extends to near the roller 41 along the upper surface 21. Similarly, the second inlet guide 62 has a recessed or concave portion which faces the roller 42. The second inlet guide 62 also has the protruding portion 64 which extends to near the roller 42 along the lower surface 22. The protruding portions 63 and 64 serve to guide movement of the strip member 20 immediately before being rolled by the roller unit 40.

After the strip member 20 is rolled or bent by the roller unit 40, the outlet guide 65 works to limit or restrain movement of the bent portion 25 of the strip member 20 in the thickness-wise direction and outward and inward radial directions of the bent portion 25 of strip member 20 and also guide the movement of the bent portion 25 in a conveying direction thereof. The outlet guide 65, as clearly illustrated in FIG. 3, includes the first outlet guide 66 and the second outlet guide 67. The first outlet guide 66 contacts the upper surface 26 of the bent portion 25 of the strip member 20. The second outlet guide 67 contacts the lower surface 27, the side surface 28, and the side surface 29 of the bent portion 25. The side surfaces 28 and 29 are opposed to each other through the width of the bent portion 25.

The first outlet guide 66 has a recessed or concave portion which faces the roller 41. The first outlet guide 66 also has the protruding portion 68 which extends to near the roller 41 along the upper surface 26 of the bent portion 25. Similarly, the second outlet guide 67 has a recessed or concave portion which faces the roller 42. The second outlet guide 67 also has the protruding portion 69 which extends to near the roller 42 along the lower surface 27 of the bent portion 25. The protruding portions 68 and 69 serve to guide movement of the bent portion 25 immediately after the strip member 20 is rolled by the roller unit 40.

The tension rollers 51 and 52 are arranged non-parallel to the rollers 41 and 42. In other words, the tension rollers 51 and 52 extend non-parallel to the rollers 41 and 42. The tension rollers 51 and 52 are arranged, as illustrated in FIG. 4, to have rotational axes c3 and c4, respectively, which extend in a direction of radius of curvature of the bent portion 25. The tension-applying direction f that is a direction in which the tension device 50 applies tension the strip member 20 is different from the rolling direction d in which the roller unit 40 rolls and feed the strip member 20 at a location where the roller unit 40 is arranged. The tension-applying direction f may be, as described above, different from the rolling direction d, for example, set to the width-wise direction of the strip member 20.

A degree of force, as produced by the tension rollers 51 and 52, to hold the bent portion 25 therebetween is less than that exerted by the roller unit 40 on the strip member 20 and is set to a degree required to stretch and convey the bent portion 25 in the tension-applying direction f. “conveying”, as referred to herein, means feeding of the strip member 20 in a direction in which a curved length of the bent portion 25 extends. A tensile force exerted by the tension rollers 51 and 52 on the bent portion 25 is selected to be within a range of 50 to 300 Mpa. The tension rollers 51 and 52 are controlled to rotate at a speed higher than that at which the rollers 41 and 42 rotate, thereby creating tension applied to a rolled portion of the strip member 20. In other words, a difference in rotational speed between a set of the tension rollers 51 and 52 and a set of the rollers 41 and 42 produces the tension exerted on the strip member 20. Usually, after being rolled by the roller unit 40, the strip member 20 has waves in the lengthwise direction thereof (i.e., the rolling direction) in the form of wrinkles. The tension-applying direction f is, therefore, preferably set to a direction, as clearly illustrated in FIG. 7, perpendicular to the width-wise direction of the strip member 20, but however, may alternatively be selected to another direction. Specifically, the circumferential velocity υ2 of the axial center of a portion of each of the tension rollers 51 and 52 which contacts the bent portion 25 is selected to be higher than the circumferential velocity υ1 of the axial center of a portion of each of the rollers 41 and 42 which contacts the strip member 20, thereby developing a desired degree of tension applied to the strip member 20.

### Beneficial Advantages

The roll bending machine 10 in the first embodiment is, as described above, equipped with the roller unit 40 and the tension device 20. The roller unit 40 works to press the strip member 20 at rolling rates different from each other in the width-wise direction of the strip member 20. The tension device 50 works to apply the tension to the strip member 20 in the rolling direction (i.e., the tension-applying direction f, in other words, the lengthwise direction of the strip member 20 in this embodiment) downstream of the roller unit 40, thereby reducing compressive stress remaining in the strip member 20 which usually results in wrinkles on the strip member 20, which minimizes a risk of producing wrinkles.

The tension-applying direction f in which the tensile force is applied by the tension device 50 to the strip member 20 is different from the rolling direction d in which the strip member 20 is rolled and bent at a location where the rolling unit 40 is disposed, thereby optimizing the exertion of tension on the strip member 20 (i.e., the bent portion 25) after being curved or bent by the roller unit 40.

The roll bending machine 10 is also equipped with the inlet guide 60 which holds the strip member 20 from moving both in the thickness-wise direction and in the width-wise direction thereof to guide movement of the strip member 20 in the conveying direction before the strip member 20 is pressed by the roller unit 40, thereby ensuring the stability in conveying the strip member 20 to a desired location in the roller unit 40.

The roll bending machine 10 is also equipped with the outlet guide 65 which holds the strip member 20 from being moved in the thickness-wise direction thereof and also holds the bent portion 25 from being moved in the outward and inward radial directions thereof to guide movement of the strip member 20 in the conveying direction after the strip member 20 is pressed by the roller unit 40, thereby minimizing a variation in diameter of the bent portion 25 of the strip member 20.

The tension device 50 is equipped with the tension rollers 51 and 52 which rotate while gripping the strip member 20 in the thickness-wise direction thereof. The circumferential velocity υ2 of the axial center of a portion of each of the tension rollers 51 and 52 which contacts the bent portion 25 is, as described above, selected to be higher than the circumferential velocity υ1 of the axial center of a portion of each of the rollers 41 and 42 which contacts the strip member 20. This enables the structure of the tension device 50 to be simplified.

### Second Embodiment

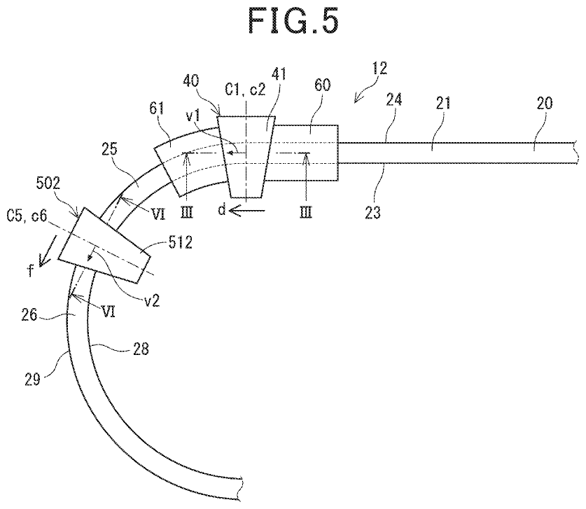

The roll bending machine 12 according to the second embodiment will be described below with reference to FIGS. 5 and. 6.

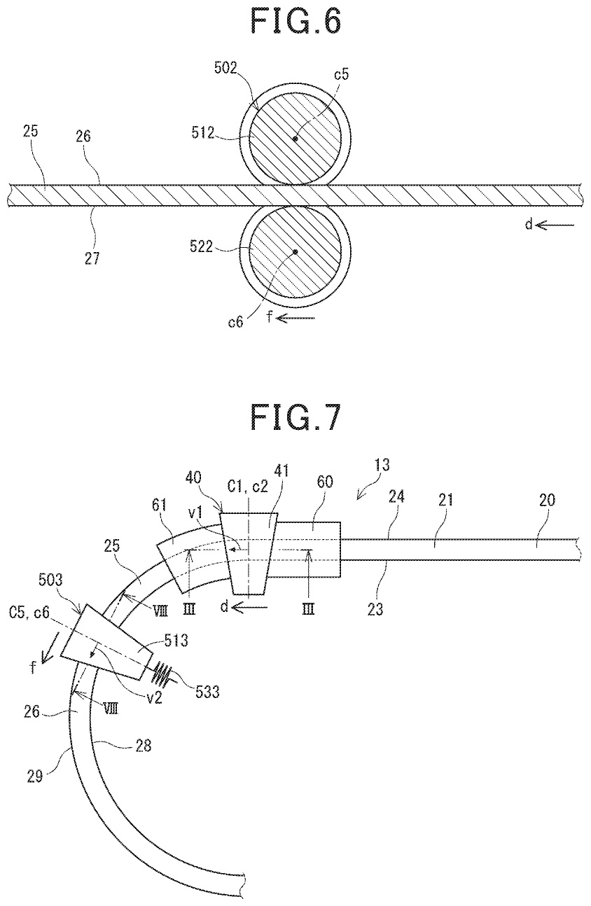

The roll bending machine 12 includes the tension device 502 which is equipped with a pair of tension rollers 512 and 522. Each of the tension rollers 512 and 522 is shaped to have a portion which contacts the bent portion 25 of the strip member 20 and has an outer diameter increasing from one end to the other end of an axial length thereof. Specifically, each of the tension rollers 512 and 522 is made of a tapered roller whose outer diameter changes linearly in the rotation axis c5 or c6, The outer periphery of the tension roller 512, as clearly illustrated in FIG. 6, contacts or presses the upper surface 26 of the bent portion 25 of the strip member 20, while the outer periphery of the tension 522 contacts or presses the lower surface 27 of the bent portion 25 of the strip member 20.

The circumferential velocity of each of the tension rollers 512 and 522 increases a small-diameter portion to a large-diameter portion thereof, thereby causing a difference in circumferential velocity between the small-diameter portion and the large-diameter portion of each of the tension rollers 512 and 522 to match a difference in velocity between outside and inside edges of the bent portion 25 of the strip member 20, thereby ensuring the stability in applying tension to the strip member 20. Other arrangements of the roll bending machine 12 in the second embodiment are identical with those of the roll bending machine 10 in the first embodiment. The roll bending machine 12 offers substantially the same beneficial advantages as those in the first embodiment.

### Third Embodiment

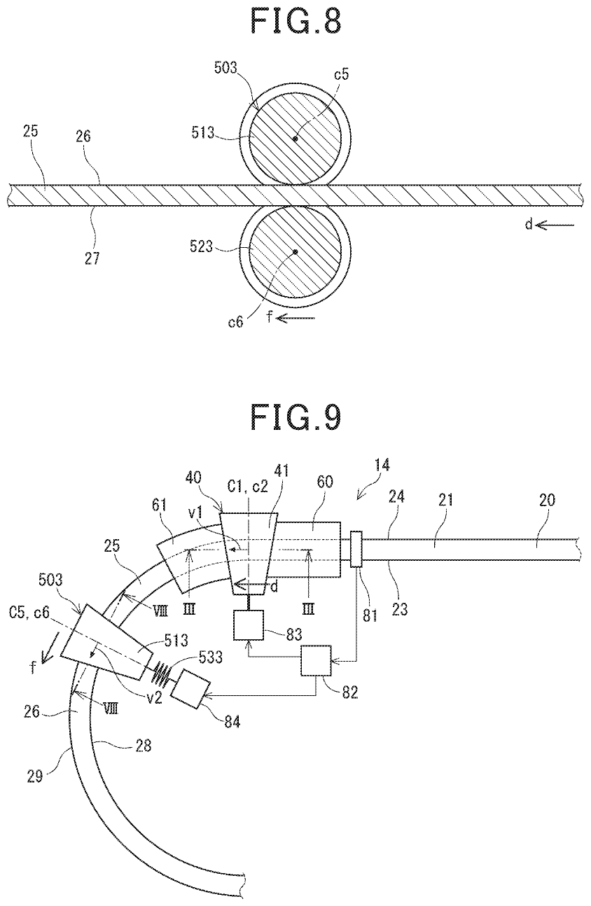

The roll bending machine 13 according to the third embodiment will be described below with reference to FIGS. 7 and 8.

The roll bending machine 13 includes the tension device 503 which is equipped with a pair of tension rollers 513 and 523. Specifically, each of the tension rollers 513 and 523 is, like the tension rollers 512 and 522 in the second embodiment, made of a tapered roller and movable in the width-wise direction of the strip member 20.

The tension rollers 513 and 532 are moved by the biasing member 533 (e.g., a spring) in the width-wise direction of the strip member 20 so as to follow a change in radius of curvature of the bent portion 25 of the strip member 20, thereby ensuring the stability in applying a required degree of tension to the strip member 20 regardless of a change in radius of curvature of the bent portion 25. The tension rollers 513 and 532 may alternatively be moved using, for example, an electrically-controlled actuator instead of the biasing member 533. Other arrangements of the roll bending machine 13 in the third embodiment are identical with those of the roll bending machine 12 in the second embodiment. The roll bending machine 13 offers substantially the same beneficial advantages as those in the second embodiment.

### Fourth Embodiment

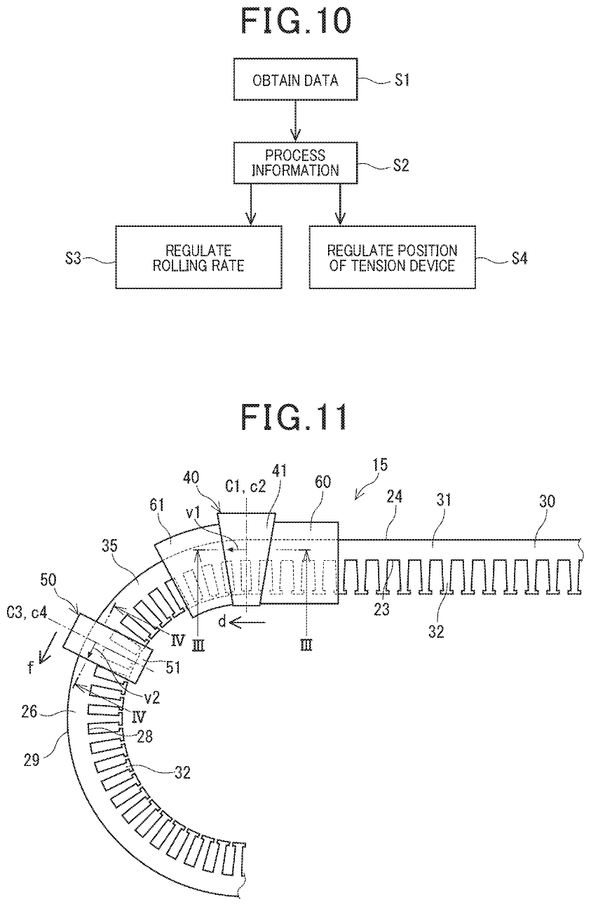

The roll bending machine 14 according to the fourth embodiment will be described below with reference to FIGS. 9 and 10.

The roll bending machine 14 includes the information acquiring unit 81, the machining condition changing unit 82, the rolling rate regulator 83, and the position regulator 84. The information acquiring unit 81 obtains information about the strip member 20. The machining condition changing unit 82 analyzes the information, as derived by the information acquiring unit 81, to change the rolling rate of the roller unit 40 and positions of the tension rollers 513 and 523 (i.e., a position of each of the tension rollers 513 and 523 relative to the strip member 20 in the width-wise direction of the strip member 20). The rolling rate regulator 83 work to control the rolling rate at which the roller unit 40 rolls or presses the strip member 20. The position regulator 84 controls the positions of the tension rollers 513 and 523.

The information derived by the information acquiring unit 81 is information about mechanical characteristics and dimensions of the strip member 20. For example, the mechanical characteristics include a value of yield stress of the strip member 20. The yield stress of the strip member 20 may be derived in a variety of known ways. The dimensions include a thickness of the strip member 20. The mechanical characteristics may also include other mechanical properties of the strip member 20. The dimensions may also include dimensions of the strip member 20 other than the thickness. The information acquiring unit 81 may be equipped with a laser sensor to measure the dimension of the strip member 20.

The machining condition changing unit 82, as clearly shown in step S1 in FIG. 10, first obtains data on the above information derived by the information acquiring unit 81. The data is derived cyclically or sequentially while the strip member 20 is being conveyed. The machining condition changing unit 82 then processes or analyzes the data to determine a target rolling rate at which the roller unit 40 is required to roll the strip member 20 and a target position of the tension rollers 513 and 523 in step S2. Subsequently, the machining condition changing unit 82 outputs a control signal to the rolling rate regulator 83 to regulate the rolling rate at which the roller unit 40 rolls the strip member 20 to the target value in step S3. Specifically, the machining condition changing unit 82 regulates or alters an interval between the rollers 41 and 42 through the thickness of the strip member 20 to provide a required rolling rate. A difference in rolling rate between the outside and inside of the strip member 20 in the width-wise direction may be created in the mariner as described above. Additionally, the machining condition changing unit 82 also outputs in step S4 a control signal to the position regulator 84 to regulate the positions of the tension rollers 513 and 523 to the target value for ensuring the stability in applying a required degree of tension to the strip member 20 regardless of a change in radius of curvature of the bent portion 25.

The roll bending machine 14 in the fourth embodiment, as described above, acquires the mechanical property and the dimension(s) of the strip member 20 before being machined by the roller unit 40 to change the machining conditions in real time, thereby minimizing a variation in radius of curvature of the bent portion 25 of the strip member 20.

Other arrangements of the roll bending machine 14 in the fourth embodiment are identical with those of the roll bending machine 13 in the third embodiment. The roll bending machine 14 offers substantially the same beneficial advantages as those in the third embodiment.

### Fifth Embodiment

The roll bending machine 15 according to the fifth embodiment will be described below with reference to FIG. 11. The roll bending machine 15 is engineered to subject the strip member 30 to the rolling and bending. The strip member 30 is the material of a stator core of an electric motor and includes the strip yoke 31 which is similar in configuration to the strip member 20 used in the first embodiment and the teeth 32.

The roller unit 40 works to press the strip yoke 31 at a rolling rate increasing from one side (from which the teeth 32 extend) to the other side of the strip yoke 31 which are opposed to each other in the width-wise direction of the strip yoke 31, thereby bending the strip yoke 31 so as to have the teeth 32 face inwardly. The tension device 50 works to exert tension to the bent portion 35 to eliminate the probability of wrinkles thereon and also wind the bent portion 35 in a spiral form.

Other arrangements of the roll bending machine 15 in the fifth embodiment are identical with those of the roll bending machine 10 in the first embodiment. The roll bending machine 15 offers substantially the same beneficial advantages as those in the first embodiment.

### Modifications

The rollers of the roller unit 40 in the above embodiments may alternatively be designed to have an outer diameter changing non-linearly in the axial direction thereof. Similarly, the tension rollers of the tension device 50, 502, or 503 may alternatively be shaped to have an outer diameter changing non-linearly in the axial direction thereof.

The tension device 50, 502, or 503 may alternative be designed to hold and then pull the strip member 20 or firmly engage and then pull the strip member 20 without use of rollers.

Either or both of the inlet guide 60, and the outlet guide 65 may be omitted.

The tension device 50, 502, or 503 may be arranged close to the roller unit 40. The tension device 50, 502, or 503 may be disposed in the outlet guide 65. In the first to fifth embodiments, an arc of the bent portion 25 or 35 between the roller unit 40 and the tension device 50, 502, or 503 has a central angle of 80°, but may be selected to be less than 80°, for example, 15° to 45°.

While the present invention has been disclosed in terms of the preferred embodiment in order to facilitate better understanding thereof, it should be appreciated that the invention can be embodied in various ways without departing from the principle of the invention. Therefore, the invention should be understood to include all possible embodiments and modifications to the shown embodiment which can be embodied without departing from the principle of the invention as set forth in the appended claims.

What is claimed is:

1. A roll bending machine comprising;
a roller unit which works to roll a strip member at a rolling rate varying in a width-wise direction of the strip member to bend the strip member; and
a tension device which works to exert tension to the strip member after the strip member is rolled.

2. The roll bending machine as set forth in claim 1, wherein a tension-applying direction in which the tension device applies the tension to the strip member is different from a rolling direction in which the strip member is rolled at a location of the roller unit.

3. The roll bending machine as set forth in claim 1, further comprising an inlet guide which works to hold the strip member from being moved both in a thickness-wise direction and in the width-wise direction of the strip member before the strip member is rolled by the roller unit and guide movement of the strip member in a conveying direction in which the strip member is conveyed.

4. The roll bending machine as set forth in claim 1, further comprising an outlet guide which works to hold the strip member from being moved in the thickness-wise direction of the strip member and also hold a bent portion of the strip member from being moved in outward and inward radial directions thereof after the strip member is rolled by the roller unit and guide movement of the strip member in the conveying direction.

5. The roll bending machine as set forth in claim 1, wherein the roller unit includes a pair of rollers which rotate while gripping a thickness of the strip member, wherein the tension device includes a pair of tension rollers which rotate while gripping the thickness of the strip member, and wherein the tension rollers are arranged non-parallel to the rollers of the roller unit.

6. The roll bending machine as set forth in claim 5, wherein a circumferential velocity of an axial center of a portion of each of the tension rollers which contacts the strip member is selected to be higher than a circumferential velocity of an axial center of a portion of each of the rollers of the roller unit which contacts the strip member.

7. The roll bending machine as set forth in claim 6, wherein each of the tension rollers has a portion which contacts the strip member and has an outer diameter increasing from one side to the other side of an axial length thereof.

8. The roll bending machine as set forth in claim 5, wherein the tension rollers are movable in the width-wise direction of the strip member.

9. The roll bending machine as set forth in claim 8, further comprising an information acquiring unit and a machining condition changing unit, the information acquiring unit obtaining a mechanical property and a dimension of the strip member, the machining condition changing unit regulating a rate of the roller unit and positions of the tension rollers based on the mechanical property and the dimension of the strip member obtained by the information acquiring unit.

10. The roll bending machine as set forth in claim 1, wherein the tension device works to exert the tension to the strip member in a direction in which the strip member has been rolled.
